(19) United States
(12) Patent Application Publication
(10) Pub. No.: US 2019/0350261 A1
(43) Pub. Date: Nov. 21, 2019

(54) ELECTRONIC CIGARETTE DEVICE

(71) Applicant: Shenzhen Jinzhuoheng Electronic Technology Co., Ltd, Shenzhen (CN)

(72) Inventor: Yiyong Wang, Shenzhen (CN)

(73) Assignee: Shenzhen Jinzhuoheng Electronic Technology Co., Ltd, Shenzhen (CN)

(21) Appl. No.: 16/413,908

(22) Filed: May 16, 2019

(30) Foreign Application Priority Data
May 17, 2018 (CN) 2018207392962

(51) Int. Cl. A24F 47/00; F16J 15/02

(52) U.S. Cl. CPC A24F 47/008; F16J 15/022

(57) ABSTRACT

An electronic cigarette device is disclosed and configured for being relatively compact. In at least one embodiment, a housing provides a suction port at a top end thereof, and a base is engaged with a bottom end of the housing. An atomizer is positioned within the housing, and a battery is positioned within the housing in a side-by-side arrangement with the atomizer. The battery is in electrical communication with a heating element of the atomizer. During use of the device, an oil absorption material of the atomizer wicks a volume of smoke oil from an oil reservoir of the atomizer, and the heating element heats the oil absorption material which, in turn, atomizes said smoke oil, allowing the vapor to then be inhaled via the suction port.

### RELATED APPLICATIONS

This application claims priority and is entitled to the filing date of CN application serial number 2018207392962, filed on May 17, 2018. The contents of the aforementioned application are incorporated herein by reference.

### BACKGROUND

The subject of this patent application relates generally to electronic cigarettes, and more particularly to an electronic cigarette device configured for being relatively compact and disposable.

Applicant(s) hereby incorporate herein by reference any and all patents and published patent applications cited or referred to in this application.

By way of background, in recent years, with the development of science and technology and society, people have gradually realized the harm to the body caused by smoking tobacco, and so have gradually restricted or even prohibited smoking tobacco in some occasions, so as not to affect people's health and the surrounding environment. However, since most smokers have become addicted to smoking, it is not easy to completely quit smoking tobacco. Therefore, an electronic cigarette product has emerged, that is, the liquid containing nicotine is atomized by electric heating, which is popular in the market at present. The demand of smokers is satisfied by sucking this vapor, and there is a tendency to replace tobacco to some extent.

At present, the electronic cigarette products on the market heat an electronic cigarette liquid through an electric heating element, so that after the electronic cigarette liquid is atomized, the vapor of electronic cigarette, rather than the smoke generated by burning, is sucked. Therefore, liquid particles rather than solid particles are sucked. The liquid particles are produced by artificial electronic cigarette liquid, and the content of various substances can be basically controlled accurately, and tar appeared when burning, which is the most harmful substance to human body, will not be produced.

There are many kinds of existing electronic cigarettes, including disposable electronic cigarettes, which are suitable for the broad market due to their simple structure and low cost. Currently known disposable electronic cigarette typically comprise a housing, an atomizer and a battery which are positioned in the housing. The atomizer and the battery are sequentially arranged along the length direction of the housing, which makes the disposable electronic cigarettes longer (such that a part of the electronic cigarette will be exposed when placed in a standard sized pocket) and very inconvenient to carry.

Aspects of the present invention solve these problems and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing an electronic cigarette device configured for being relatively compact and disposable. In at least one embodiment, a housing provides a suction port at a top end thereof, and a base is engaged with a bottom end of the housing. An atomizer is positioned within the housing. An oil reservoir is engaged with a fixing seat of the atomizer and configured for storing a volume of smoke oil. An atomizing bin is positioned within the oil reservoir and engaged with the fixing seat, such that a gap is formed between an inner wall of the oil reservoir and an outer wall of the atomizing bin. A heating element is positioned within the atomizing bin. An oil absorption material is positioned substantially within the atomizing bin and engaged with the heating element, a portion of the oil absorption material extending a distance into the oil reservoir. A vapor guiding pipe is positioned and configured for creating fluid communication between the atomizing bin and the suction port. A battery is positioned within the housing in a side-by-side arrangement with the atomizer, the battery in electrical communication with heating element. During use of the device, the oil absorption material wicks a volume of smoke oil from the oil reservoir, and the heating element heats the oil absorption material which, in turn, atomizes said smoke oil, allowing the vapor to then be inhaled via the suction port.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary electronic cigarette device, in accordance with at least one embodiment;

FIG. 2 is a cross-sectional view taken along line 2-2 of FIG. 1;

FIG. 3 is an exploded view of the exemplary electronic cigarette device, in accordance with at least one embodiment; and

FIG. 4 is a detailed view of the section defined by line A of FIG. 3.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

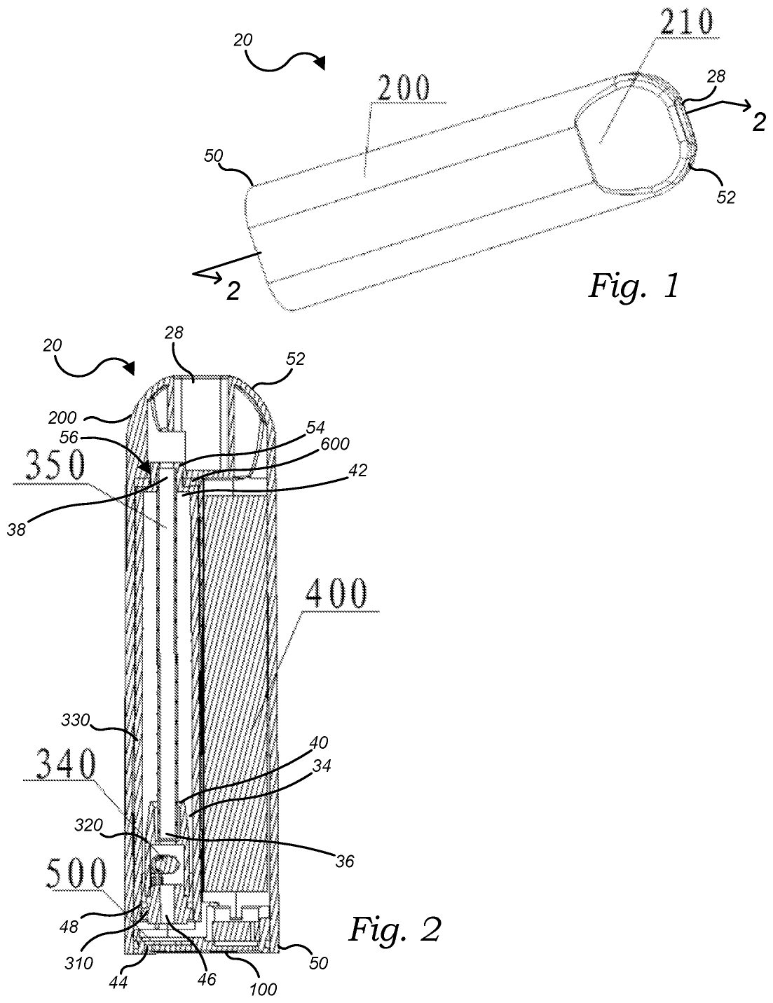

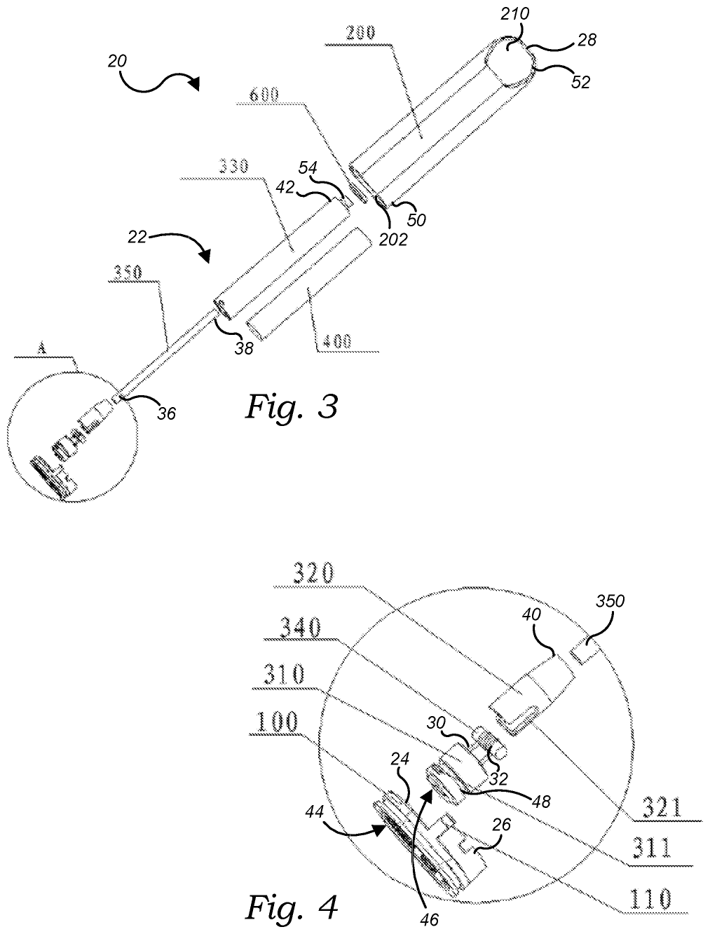

Turning now to FIGS. 1-4, there is shown an exemplary electronic cigarette device 20, in accordance with at least one embodiment. In at least one embodiment, the device 20 provides a housing 200 and a base 100 engaged with the housing 200. In at least one embodiment, opposing side walls of the base 100 provide a pair of clamping hooks 110 extending in a direction toward the housing 200. The clamping hooks 110 face away from each other, and an inner surface 202 of the housing 200 provides a pair of recesses (not shown) positioned and configured for engagement with the corresponding clamping hooks 110, thereby allowing the base 100 to be engaged with the housing 200.

In at least one embodiment, within the housing is positioned an atomizer 22 and a battery 400. In at least one embodiment, the base 100 comprises a first fixing part 24 and a laterally opposed second fixing part 26, which are arranged at left and right sides thereof, respectively. The first fixing part 24 engages the atomizer 22, while the second fixing part 26 engages the battery 400. Additionally, the housing 200 provides a suction port 28. In at least one embodiment, through reasonable structural arrangement, the atomizer 22 and the battery 400 are arranged in a side-by-side arrangement within the housing 200, so that a length of the device 20 can be significantly reduced, and the device 20 is more convenient to carry. It should be noted that the specific size, shape and dimensions of the housing 200 depicted in the drawings is merely exemplary. As such, in further embodiments, the housing 200 may take on any other size, shape or dimensions—now known or later conceived—so long as the device 20 is capable of substantially carrying out the functionality described herein.

In a bit more detail, in at least one embodiment, the atomizer 22 comprises a fixing seat 310, a heating element 30 (such as a wire, for example), an oil absorption material 340, an atomizing bin 320 and an oil reservoir 330. In at least one such embodiment, the oil absorption material 340 is cotton. However, in further embodiments, the oil absorption material 340 may be any other material (or combination of materials)—now known or later developed—capable of allowing the device 20 to substantially carry out the functionality described herein. In at least one embodiment, the heating element 30 comprises a spiral fixing part 32 and a connecting part engaged with the fixing seat 310, such that the oil absorption material 340 is inserted into the spiral fixing part 32. In at least one embodiment, the atomizing bin 320 is fixed on the fixing seat 310, and the heating element 30 and the oil absorption material 340 are positioned in the atomizing bin 320. In at least one embodiment, the oil reservoir 330 is sleeved on the fixing seat 310, and the atomizing bin 320 is positioned inside the oil reservoir 330, such that there is a gap 34 between an inner wall of the oil reservoir 330 and an outer wall of the atomizing bin 320. In at least one such embodiment, the gap 34 is used for containing a volume of smoke oil (not shown). Although the device 20 is a disposable electronic cigarette in at least one embodiment, the device 20 can nevertheless ensure a certain duration for continuous provision of smoke oil. In at least one embodiment, the atomizing bin 320 provides a notch 321 so as to enable the oil absorption material 340 to contact the smoke oil positioned within the oil reservoir 330 through the notch 321. The gap 34 between the oil reservoir 330 and the atomizing bin 320 forms an oil storage space. A portion of the oil absorption material 340 in the atomizing bin 320 extends into the oil reservoir 330, and the heating element 30 heats the oil absorption material 340. As a result, the smoke oil in the oil absorption material 340 is atomized, and the oil absorption material 340 continues to wick the smoke oil from the oil storage space, such that the device 20 can be sucked multiple times.

In at least one further embodiment, the oil absorption material 340 is transversely fixed within a pair of opposing notches 321 on the atomizing bin 320. In at least one such embodiment, the two notches 321 are symmetrically arranged, such that opposing ends of the oil absorption material 340 are respectively contacted with smoke oil in the oil reservoir 330 through the two notches 321. Additionally, in such an embodiment, both ends of the oil absorption material 340 extend into the oil storage space (i.e., the gap 34), such that the speed at which the oil absorption material 340 wicks the smoke oil is increased, and the smoke oil can be uniformly diffused from both ends of the oil absorption material 340 to a middle portion of the oil absorption material 340, and the smoke oil can be uniformly absorbed.

In at least one embodiment, the atomizer 22 comprises a vapor guiding pipe 350, with a first end 36 of the vapor guiding pipe 350 connected to the atomizing bin 320, and an opposing second end 38 of the vapor guiding pipe 350 connected to the oil reservoir 330. In at least one such embodiment, the vapor guiding pipe 350 is used for interconnecting the atomizing bin 320 with the environment outside of the housing 200, so that vapor generated in the atomizing bin 320 is sucked out of the housing 200 (via the suction port 28) after passing through the vapor guiding pipe 350. In at least one such embodiment, the first end 36 of the vapor guiding pipe 350 is fixedly inserted into, and hermetically connected with, an upper end 40 of the atomizing bin 320, while the second end 38 of the vapor guiding pipe 350 is tightly inserted into an upper end 42 of the oil reservoir 330.

In at least one embodiment, the first fixing part 24 of the base 100 provides an air hole 44 in fluid communication with the environment outside of the housing 200. In at least one such embodiment, the fixing seat 310 provides an air guiding hole 46 positioned opposite the air hole 44. An airflow induction switch 500 is positioned between the air hole 44 and the air guiding hole 46, such that the airflow induction switch 500 is capable of controlling the opening and closing of the atomizer 22. During use of the device 20 in such embodiments, airflow passes through the airflow induction switch 500, which starts the atomizer 22, and the heating element 30 heats the oil absorption material 340 which, in turn, atomizes the smoke oil in the oil absorption material 340. When the user of the device 20 ceases to inhale, airflow no longer passes through the airflow induction switch 500, such that atomizer 22 is deactivated.

In at least one embodiment, in order to facilitate the installation of the fixing seat 310 and the oil reservoir 330 in a way as to prevent the smoke oil in the oil reservoir 330 from leaking out, opposing sides of the fixing seat 310 provide protrusions 311, while opposing sides of the oil reservoir 330 provide clamping holes (not shown) positioned and configured for engagement with the corresponding protrusions 311. In at least one such embodiment, a side of each protrusion 311, closest to the oil reservoir 330, provides an inclined surface, such that a distance between the inclined surfaces of the two protrusions 311 gradually increases in a direction away from the oil reservoir 330 toward the fixing seat 310, so as to engage the oil reservoir 330 with the fixing seat 310. In at least one embodiment, the material of the oil reservoir 330 is plastic. The opposite sides of the oil reservoir 330 are expanded by the inclined surfaces of the protrusions 311 when the protrusions 311 engage with the corresponding clamping holes. As a result, the protrusions 311 are clamped in the corresponding clamping holes, and the oil reservoir 330 is prevented from being subsequently pulled out.

In at least one embodiment, in order to increase the sealing performance of the oil reservoir 330, a circumferential side wall of the fixing seat 310 provides an annular groove 48 for fixing a sealing ring (not shown).

In at least one embodiment, so as to increase the comfort for the user during use of the device 20, the housing 200 provides an ergonomically shaped suction port 28. In at least one such embodiment, the suction port 28 provides a pair of opposing curved surfaces 210. A distance between the two curved surfaces 210 gradually decreases in a direction away from a bottom end 50 of the housing 200 toward the suction port 28. Additionally, in at least one embodiment, the opposing curved surfaces 210 converge at a relatively flat surface at a top end 52 of the housing 200, with the flat surface sized and shaped for substantially conforming to a mouth of the user.

In at least one embodiment, the oil reservoir 330 provides a connecting pipe part 54 positioned within the housing 200. The connecting pipe part 54 is in fluid communication with the vapor guiding pipe 350 and extends through an engaging hole 56 provided by the housing 200, when the housing 200 is engaged with the base 100. Thus, the connecting pipe part 54 is also in fluid communication with the suction port 28. A sealing compression ring 600 is positioned between the engaging hole 56 and the connecting pipe part 54 so as to fill any gap therebetween, thereby making the structure more compact. In at least one embodiment, the compression ring 600 is constructed out of rubber.

Aspects of the present specification may also be described as the following embodiments:

1. An electronic cigarette device comprising: a housing providing a suction port at a top end thereof; a base engaged with a bottom end of the housing; an atomizer positioned within the housing, the atomizer comprising: a fixing seat; an oil reservoir engaged with the fixing seat and configured for storing a volume of smoke oil; an atomizing bin positioned within the oil reservoir and engaged with the fixing seat, such that a gap is formed between an inner wall of the oil reservoir and an outer wall of the atomizing bin; a heating element positioned within the atomizing bin; an oil absorption material positioned substantially within the atomizing bin and engaged with the heating element, a portion of the oil absorption material extending a distance into the oil reservoir; and a vapor guiding pipe positioned and configured for creating fluid communication between the atomizing bin and the suction port; and a battery positioned within the housing in a side-by-side arrangement with the atomizer, the battery in electrical communication with heating element; whereby, the oil absorption material wicks a volume of smoke oil from the oil reservoir, and the heating element heats the oil absorption material which, in turn, atomizes said smoke oil, allowing the vapor to then be inhaled via the suction port.

2. The electronic cigarette device according to embodiment 1, wherein each of the atomizer and battery is engaged with the base.

3. The electronic cigarette device according to embodiments 1-2, wherein: the base provides a first fixing part and a laterally opposed second fixing part; the first fixing part is engaged with the atomizer; and the second fixing part is engaged with the battery.

4. The electronic cigarette device according to embodiments 1-3, wherein the oil absorption material is cotton.

5. The electronic cigarette device according to embodiments 1-4, wherein the heating element comprises a connecting part engaged with the fixing seat and a spiral fixing part, whereby the oil absorption material is inserted into the spiral fixing part.

6. The electronic cigarette device according to embodiments 1-5, wherein the atomizing bin provides an at least one notch positioned and configured for allowing the oil absorption material to extend therethrough so as to contact the smoke oil positioned within the oil reservoir.

7. The electronic cigarette device according to embodiments 1-6, wherein the gap between the oil reservoir and the atomizing bin forms an oil storage space configured for storing a volume of the smoke oil.

8. The electronic cigarette device according to embodiments 1-7, wherein the atomizing bin provides a pair of opposing notches positioned and configured for allowing the oil absorption material to be transversely fixed therewithin, such that opposing ends of the oil absorption material each contact the smoke oil positioned within the oil reservoir.

9. The electronic cigarette device according to embodiments 1-8, wherein a first end of the vapor guiding pipe is engaged with an upper end of the atomizing bin, and an opposing second end of the vapor guiding pipe is engaged with an upper end of the oil reservoir.

10. The electronic cigarette device according to embodiments 1-9, wherein the oil reservoir provides a connecting pipe part in fluid communication with the vapor guiding pipe, the connecting pipe part extending through an engaging hole provided by the housing and configured for creating fluid communication between the vapor guiding pipe and the suction port.

11. The electronic cigarette device according to embodiments 1-10, further comprising a sealing compression ring positioned between the engaging hole and the connecting pipe part.

12. The electronic cigarette device according to embodiments 1-11, wherein the sealing compression ring is constructed out of rubber.

13. The electronic cigarette device according to embodiments 1-12, wherein: the base provides an air hole extending therethrough; the fixing seat provides an air guiding hole extending therethrough, the air guiding hole configured for creating fluid communication between the air hole and the atomizer; and the base further provides an airflow induction switch positioned between the air hole and the air guiding hole, the airflow induction switch configured for selectively allowing an electrical current to flow from the battery to the heating element, upon a volume of air passing through the airflow induction switch, thereby allowing the heating element to heat the oil absorption material.

14. The electronic cigarette device according to embodiments 1-13, further comprising: a pair of clamping holes positioned on opposing sides of the oil reservoir; and a pair of protrusions positioned on opposing sides of the fixing seat and configured for engagement with the corresponding clamping holes.

15. The electronic cigarette device according to embodiments 1-14, wherein a side of each protrusion, closest to the oil reservoir, provides an inclined surface, such that a distance between the inclined surfaces of the two protrusions gradually increases in a direction away from the oil reservoir toward the fixing seat, so as to securely engage the oil reservoir with the fixing seat.

16. The electronic cigarette device according to embodiments 1-15, further comprising: a pair of clamping hooks positioned on opposing side walls of the base and extending in a direction toward the housing; and an inner surface of the housing providing a pair of recesses positioned and configured for engagement with the corresponding clamping hooks, thereby allowing the base to be engaged with the housing.

17. The electronic cigarette device according to embodiments 1-16, wherein a circumferential side wall of the fixing seat provides an annular groove, within which is positioned a sealing ring, the sealing ring configured for creating a frictional engagement between the fixing seat and an inner wall of the oil reservoir.

18. The electronic cigarette device according to embodiments 1-17, wherein the suction port is ergonomically shaped, with the housing providing a pair of opposing curved surfaces that taper inwardly toward a relatively flat surface on which the suction port is positioned.

19. An electronic cigarette device comprising: a housing providing a suction port at a top end thereof; a base engaged with a bottom end of the housing; an atomizer positioned within the housing, the atomizer comprising: a fixing seat; an oil reservoir engaged with the fixing seat and configured for storing a volume of smoke oil; an atomizing bin positioned within the oil reservoir and engaged with the fixing seat, such that a gap is formed between an inner wall of the oil reservoir and an outer wall of the atomizing bin; a heating element positioned within the atomizing bin; an oil absorption material positioned substantially within the atomizing bin and engaged with the heating element, a portion of the oil absorption material extending a distance through an at least one notch in the atomizing bin and into the oil reservoir; and a vapor guiding pipe positioned and configured for creating fluid communication between the atomizing bin and the suction port; and a battery positioned within the housing in a side-by-side arrangement with the atomizer, the battery in electrical communication with heating element; whereby, the oil absorption material wicks a volume of smoke oil from the oil reservoir, and the heating element heats the oil absorption material which, in turn, atomizes said smoke oil, allowing the vapor to then be inhaled via the suction port.

20. An electronic cigarette device comprising: a housing providing a suction port at a top end thereof; a base engaged with a bottom end of the housing, the base providing an air hole extending therethrough; an atomizer positioned within the housing, the atomizer comprising: a fixing seat providing an air guiding hole extending therethrough, the air guiding hole configured for creating fluid communication between the air hole and the atomizer; an oil reservoir engaged with the fixing seat and configured for storing a volume of smoke oil; an atomizing bin positioned within the oil reservoir and engaged with the fixing seat, such that a gap is formed between an inner wall of the oil reservoir and an outer wall of the atomizing bin; a heating element positioned within the atomizing bin; an oil absorption material positioned substantially within the atomizing bin and engaged with the heating element, a portion of the oil absorption material extending a distance into the oil reservoir; and a vapor guiding pipe positioned and configured for creating fluid communication between the atomizing bin and the suction port; a battery positioned within the housing in a side-by-side arrangement with the atomizer, the battery in electrical communication with heating element; and an airflow induction switch positioned between the air hole and the air guiding hole, the airflow induction switch configured for selectively allowing an electrical current to flow from the battery to the heating element, upon a volume of air passing through the airflow induction switch, thereby allowing the heating element to heat the oil absorption material whereby, the oil absorption material wicks a volume of smoke oil from the oil reservoir, and the heating element heats the oil absorption material which, in turn, atomizes said smoke oil, allowing the vapor to then be inhaled via the suction port.

In closing, regarding the exemplary embodiments of the present invention as shown and described herein, it will be appreciated that an electronic cigarette device is disclosed and configured for being relatively compact and disposable. Because the principles of the invention may be practiced in a number of configurations beyond those shown and described, it is to be understood that the invention is not in any way limited by the exemplary embodiments, but is generally directed to an electronic cigarette device and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An electronic cigarette device comprising:
a housing providing a suction port at a top end thereof;
a base engaged with a bottom end of the housing;
an atomizer positioned within the housing, the atomizer comprising:
a fixing seat;
an oil reservoir engaged with the fixing seat and configured for storing a volume of smoke oil;
an atomizing bin positioned within the oil reservoir and engaged with the fixing seat, such that a gap is formed between an inner wall of the oil reservoir and an outer wall of the atomizing bin;
a heating element positioned within the atomizing bin;
an oil absorption material positioned substantially within the atomizing bin and engaged with the heating element, a portion of the oil absorption material extending a distance into the oil reservoir; and
a vapor guiding pipe positioned and configured for creating fluid communication between the atomizing bin and the suction port; and
a battery positioned within the housing in a side-by-side arrangement with the atomizer, the battery in electrical communication with heating element;
whereby, the oil absorption material wicks a volume of smoke oil from the oil reservoir, and the heating element heats the oil absorption material which, in turn, atomizes said smoke oil, allowing the vapor to then be inhaled via the suction port.

2. The electronic cigarette device of claim 1, wherein each of the atomizer and battery is engaged with the base.

3. The electronic cigarette device of claim 2, wherein:
the base provides a first fixing part and a laterally opposed second fixing part;
the first fixing part is engaged with the atomizer; and
the second fixing part is engaged with the battery.

4. The electronic cigarette device of claim 1, wherein the oil absorption material is cotton.

5. The electronic cigarette device of claim 1, wherein the heating element comprises a connecting part engaged with the fixing seat and a spiral fixing part, whereby the oil absorption material is inserted into the spiral fixing part.

6. The electronic cigarette device of claim 1, wherein the atomizing bin provides an at least one notch positioned and configured for allowing the oil absorption material to extend therethrough so as to contact the smoke oil positioned within the oil reservoir.

7. The electronic cigarette device of claim 6, wherein the gap between the oil reservoir and the atomizing bin forms an oil storage space configured for storing a volume of the smoke oil.

8. The electronic cigarette device of claim 6, wherein the atomizing bin provides a pair of opposing notches positioned and configured for allowing the oil absorption material to be transversely fixed therewithin, such that opposing ends of the oil absorption material each contact the smoke oil positioned within the oil reservoir.

9. The electronic cigarette device of claim 1, wherein a first end of the vapor guiding pipe is engaged with an upper end of the atomizing bin, and an opposing second end of the vapor guiding pipe is engaged with an upper end of the oil reservoir.

10. The electronic cigarette device of claim 11, wherein the oil reservoir provides a connecting pipe part in fluid communication with the vapor guiding pipe, the connecting pipe part extending through an engaging hole provided by the housing and configured for creating fluid communication between the vapor guiding pipe and the suction port.

11. The electronic cigarette device of claim 10, further comprising a sealing compression ring positioned between the engaging hole and the connecting pipe part.

12. The electronic cigarette device of claim 11, wherein the sealing compression ring is constructed out of rubber.

13. The electronic cigarette device of claim 1, wherein:
the base provides an air hole extending therethrough;
the fixing seat provides an air guiding hole extending therethrough, the air guiding hole configured for creating fluid communication between the air hole and the atomizer; and
the base further provides an airflow induction switch positioned between the air hole and the air guiding hole, the airflow induction switch configured for selectively allowing an electrical current to flow from the battery to the heating element, upon a volume of air passing through the airflow induction switch, thereby allowing the heating element to heat the oil absorption material.

14. The electronic cigarette device of claim 1, further comprising:
a pair of clamping holes positioned on opposing sides of the oil reservoir; and
a pair of protrusions positioned on opposing sides of the fixing seat and configured for engagement with the corresponding clamping holes.

15. The electronic cigarette device of claim 14, wherein a side of each protrusion, closest to the oil reservoir, provides an inclined surface, such that a distance between the inclined surfaces of the two protrusions gradually increases in a direction away from the oil reservoir toward the fixing seat, so as to securely engage the oil reservoir with the fixing seat.

16. The electronic cigarette device of claim 1, further comprising:
a pair of clamping hooks positioned on opposing side walls of the base and extending in a direction toward the housing; and
an inner surface of the housing providing a pair of recesses positioned and configured for engagement with the corresponding clamping hooks, thereby allowing the base to be engaged with the housing.

17. The electronic cigarette device of claim 1, wherein a circumferential side wall of the fixing seat provides an annular groove, within which is positioned a sealing ring, the sealing ring configured for creating a frictional engagement between the fixing seat and an inner wall of the oil reservoir.

18. The electronic cigarette device of claim 1, wherein the suction port is ergonomically shaped, with the housing providing a pair of opposing curved surfaces that taper inwardly toward a relatively flat surface on which the suction port is positioned.

19. An electronic cigarette device comprising:
a housing providing a suction port at a top end thereof;
a base engaged with a bottom end of the housing;
an atomizer positioned within the housing, the atomizer comprising:
a fixing seat;
an oil reservoir engaged with the fixing seat and configured for storing a volume of smoke oil;
an atomizing bin positioned within the oil reservoir and engaged with the fixing seat, such that a gap is formed between an inner wall of the oil reservoir and an outer wall of the atomizing bin;
a heating element positioned within the atomizing bin;
an oil absorption material positioned substantially within the atomizing bin and engaged with the heating element, a portion of the oil absorption material extending a distance through an at least one notch in the atomizing bin and into the oil reservoir; and
a vapor guiding pipe positioned and configured for creating fluid communication between the atomizing bin and the suction port; and
a battery positioned within the housing in a side-by-side arrangement with the atomizer, the battery in electrical communication with heating element;
whereby, the oil absorption material wicks a volume of smoke oil from the oil reservoir, and the heating element heats the oil absorption material which, in turn, atomizes said smoke oil, allowing the vapor to then be inhaled via the suction port.

20. An electronic cigarette device comprising:
a housing providing a suction port at a top end thereof;
a base engaged with a bottom end of the housing, the base providing an air hole extending therethrough;
an atomizer positioned within the housing, the atomizer comprising:
a fixing seat providing an air guiding hole extending therethrough, the air guiding hole configured for creating fluid communication between the air hole and the atomizer;
an oil reservoir engaged with the fixing seat and configured for storing a volume of smoke oil;
an atomizing bin positioned within the oil reservoir and engaged with the fixing seat, such that a gap is formed between an inner wall of the oil reservoir and an outer wall of the atomizing bin;
a heating element positioned within the atomizing bin;
an oil absorption material positioned substantially within the atomizing bin and engaged with the heating element, a portion of the oil absorption material extending a distance into the oil reservoir; and
a vapor guiding pipe positioned and configured for creating fluid communication between the atomizing bin and the suction port;
a battery positioned within the housing in a side-by-side arrangement with the atomizer, the battery in electrical communication with heating element; and
an airflow induction switch positioned between the air hole and the air guiding hole, the airflow induction switch configured for selectively allowing an electrical current to flow from the battery to the heating element, upon a volume of air passing through the airflow induction switch, thereby allowing the heating element to heat the oil absorption material
whereby, the oil absorption material wicks a volume of smoke oil from the oil reservoir, and the heating element heats the oil absorption material which, in turn, atomizes said smoke oil, allowing the vapor to then be inhaled via the suction port.
